(19) United States
(12) Patent Application Publication
(10) Pub. No.: US 2025/0116833 A1
(43) Pub. Date: Apr. 10, 2025

(54) INTERMITTENTLY BONDED OPTICAL FIBER RIBBON HAVING A REPEATING PATTERN OF BOND LENGTH AND GAP LENGTHS CONFIGURED TO ENHANCE FLEXIBILITY AND ROBUSTNESS OF THE OPTICAL FIBER RIBBON

(71) Applicant: BELDEN INC., St. Louis, MO (US)

(72) Inventors: James John ZIMNICKI, Richmond, IN (US); Annabelle SCARPACI, Douglasville, GA (US)

(73) Assignee: BELDEN INC., St. Louis, MO (US)

(21) Appl. No.: 18/912,239

(22) Filed: Oct. 10, 2024

Related U.S. Application Data
(60) Provisional application No. 63/543,463, filed on Oct. 10, 2023.
(60) Provisional application No. 63/602,072, filed on Nov. 22, 2023.

(51) Int. Cl. G02B 6/44

(52) U.S. Cl. CPC G02B 6/443

(57) ABSTRACT

An optical fiber ribbon may be intermittently bonded with a repeating pattern of bond lengths and gap lengths configured to enhance flexibility and robustness of the optical fiber ribbon. The ribbon may include a plurality of optical fibers where a first adjacent two of the optical fibers may be intermittently connected together by the bond portions arranged in a longitudinal pattern which may have a constant bond length or may have a constant distance between bond portions. A second adjacent two of the optical fibers may be intermittently connected together by the bond portions arranged in the longitudinal pattern where a first bond portion of the second adjacent two of the optical fibers may be offset from the first bond portion of the first adjacent two of the optical fibers in the longitudinal direction by a first offset length (O1).

### CROSS-REFERENCE TO RELATED APPLICATIONS

This application claims the benefit of U.S. Provisional Application No. 63/543,463, filed Oct. 10, 2023, and U.S. Provisional Application No. 63/602,072, filed Nov. 22, 2023, the disclosures of which are hereby incorporated by reference herein in their entirety.

### FIELD

The present application relates to the field of an optical fiber communication technology and, in particular, to an intermittently bonded optical fiber ribbon having a repeating pattern of bond length and gap lengths.

### BACKGROUND

The evolution of 5G and increase of data consumption over recent years have drastically increased the application of data centers and Telecoms. Large scale data centers and Telecom sectors require ultra-high fiber density cables that offer high data rate with low latency. High fiber density cables include a large number of optical fibers inside the cable. The optical fibers may be in the form of loose optical fibers and/or optical fiber ribbons. Traditionally, the structure of an optical fiber cable includes loose optical fibers or optical fiber ribbons, one or multiple buffer tubes, strength members, and an overall sheath. The buffer tube, strength members and sheath protect the optical fibers from physical damage.

Typically, the use of conventional optical fiber ribbons fully encapsulated in a ribbon matrix aka flat ribbons in a cable provides an advantage of mass fusion splicing, which reduces the splicing time. However, the use of a greater number of such optical fiber ribbons in a cable increases the overall diameter of the optical fiber cable compared to loose fibers because of its preferential bend into one axis. Also, flat optical fiber ribbons and/or intermittently bonded fiber ribbons with poor flexibility lead to low packing efficiency of the optical fiber ribbons, which in turn leads to an increase of cable diameter. Larger diameter cables lead to difficulty in handling, transport, and installation and an increase in cost. Further, conventional high fiber count cables are inefficient at junction points and manhole installations.

On the other hand, flexible optical fiber ribbons which are intermittently bonded do not have preferential bend and are capable to roll on their lateral axis increasing cable fiber density leading to higher cable fiber density to a factor by a certain factor relative to fully encapsulated ribbons. Also, an intermittently bonded optical fiber ribbon has less matrix than a full bonded ribbon, thus making it easier and quicker to terminate a fiber of an intermittently bonded ribbon with a connector and making it compatible with furcation tubing. In addition, intermittently bonded optical fiber ribbon can be compatible with furcation tubing while fully bonded ribbons are not compatible.

Therefore, it may be desirable to provide an optical fiber ribbon that includes fibers that are intermittently bonded with a repeating pattern of bond lengths and gap lengths configured to enhance flexibility and robustness of the optical fiber ribbon and minimize macrobend loss and attenuation.

### SUMMARY

According to various exemplary aspects of the disclosure, an intermittently optical fiber ribbon may include a plurality of optical fibers arranged in parallel and a connecting portion configured to connect adjacent optical fibers together. The connecting portion may include bond portions that are configured to be spaced apart from one another in a longitudinal direction.

In some embodiments, the bond portions may have a constant bond length (BL).

In some embodiments, a first adjacent two of the optical fibers may be intermittently connected together by the bond portions arranged in a longitudinal pattern where a first bond portion is separated from a second bond portion by a first distance (D1) and the second bond portion is separated from a third bond portion by a second distance (D2) that is different from the first distance.

In some embodiments, the longitudinal pattern may be repeated in the longitudinal direction.

In some embodiments, a second adjacent two of the optical fibers may be intermittently connected together by the bond portions arranged in the longitudinal pattern. In some embodiments, one of the second adjacent two of the optical fibers may be one of the first adjacent two of the optical fibers.

In some embodiments, a first bond portion of the second adjacent two of the optical fibers may be offset from the first bond portion of the first adjacent two of the optical fibers in the longitudinal direction by a first offset length (O1). In some embodiments, the first offset length may be different from the first and second distances.

In some embodiments, the first bond portion of the second adjacent two of the optical fibers may not be aligned with the first bond portion of the first adjacent two of the optical fibers in a transverse direction that is perpendicular to the longitudinal direction.

In some embodiments, a third adjacent two of the optical fibers may be intermittently connected together by the bond portions arranged in the longitudinal pattern. In some embodiments, one of the third adjacent two of the optical fibers may be a second one of the second adjacent two of the optical fibers.

In some embodiments, a first bond portion of the third adjacent two of the optical fibers may be offset from the first bond portion of the second adjacent two of the optical fibers in the longitudinal direction by a second offset length (O2) and may be offset from the first bond portion of the first adjacent two of the optical fibers in the longitudinal direction by a distance equal to O1+O2+BL.

In some embodiments, a second bond portion of the third adjacent two of the optical fibers may be offset from the second bond portion of the second adjacent two of the optical fibers in the longitudinal direction by a third offset length (O3) and may be offset from the second bond portion of the first adjacent two of the optical fibers in the longitudinal direction by a distance equal to O1+O3+BL.

In some embodiments, the intermittent connecting may include bonding.

In some embodiments, a longitudinal pattern of intermittently bonding adjacent optical fibers may be structurally configured to enhance flexibility and robustness of the optical fiber ribbon such that a density of optical fibers in a cable can be increased without increasing a diameter of the cable.

In some embodiments, the second offset length (O2) may be the same as the third offset length (O3). In some embodiments, the second offset length (O2) may be different from the third offset length (O3).

In some embodiments, a n^{th} adjacent two of the optical fibers may be intermittently connected together by the bond portions arranged in a longitudinal pattern where a first bond portion is separated from a second bond portion by a (n+2)^{th} distance different from the first distance and the second distance, where n≥3.

In some embodiments, a transverse pattern of offsetting a subsequent sequential adjacent two of the optical fibers in the longitudinal direction by the first offset length may be repeated in the transverse direction.

In some embodiments, an optical fiber cable may include the fiber ribbon disposed in a buffer tube, a strength member, and a sheath configured to surround the optical fiber ribbon, the buffer tube, and the strength member.

In some embodiments, an optical fiber cable may include the optical fiber ribbon bundled with a binder, a strength member, and a sheath configured to surround the optical fiber ribbon and the strength member.

In some embodiments, an optical fiber ribbon intermittently bonded with a repeating pattern of bond lengths and gap lengths may be structurally configured to enhance flexibility and robustness of the optical fiber ribbon. The optical fiber ribbon may include a plurality of optical fibers arranged in parallel and a connecting portion configured to connect adjacent optical fibers together.

In some embodiments, the connecting portion may include bond portions that are configured to be spaced apart from one another in a longitudinal direction.

In some embodiments, a first adjacent two of the optical fibers may be intermittently connected together by the bond portions arranged in a longitudinal pattern where a first bond portion is separated from a second bond portion by a distance and the second bond portion is separated from a third bond portion by the distance D.

In some embodiments, the first bond portion may have a first bond length BL1 and the second bond portion has a second bond length BL2 that is different than the first bond length BL1.

In some embodiments, the longitudinal pattern may be repeated in the longitudinal direction.

In some embodiments, a second adjacent two of the optical fibers may be intermittently connected together by the bond portions arranged in the longitudinal pattern.

In some embodiments, one of the second adjacent two of the optical fibers may be one of the first adjacent two of the optical fibers.

In some embodiments, a first bond portion of the second adjacent two of the optical fibers may be offset from the first bond portion of the first adjacent two of the optical fibers in the longitudinal direction by a first offset length (O1).

In some embodiments, the first bond portion of the second adjacent two of the optical fibers may not be aligned with the first bond portion of the first adjacent two of the optical fibers in a transverse direction that is perpendicular to the longitudinal direction.

In some embodiments, a third adjacent two of the optical fibers may be intermittently connected together by the bond portions arranged in the longitudinal pattern.

In some embodiments, the third adjacent two of the optical fibers may be a second one of the second adjacent two of the optical fibers.

In some embodiments, a first bond portion of the third adjacent two of the optical fibers may be offset from the first bond portion of the second adjacent two of the optical fibers in the longitudinal direction by a second offset length (O2) and may be offset from the first bond portion of the first adjacent two of the optical fibers in the longitudinal direction by a distance equal to O1+O2+BL2.

In some embodiments, the first bond length may be greater than the second bond length.

In some embodiments, the first bond length may be less than the second bond length.

In some embodiments, an optical fiber ribbon intermittently bonded with a repeating pattern of bond lengths and gap lengths may be configured to enhance flexibility and robustness of the optical fiber ribbon. In some embodiments, the optical fiber ribbon may include a plurality of optical fibers arranged in parallel and a connecting portion configured to connect adjacent optical fibers together.

In some embodiments, the connecting portion may include bond portions that are configured to be spaced apart from one another in a longitudinal direction. In some embodiments, the bond portions may have a constant bond length (BL).

In some embodiments, a first adjacent two of the optical fibers may be intermittently connected together by the bond portions arranged in a longitudinal pattern where a first bond portion may be separated from a second bond portion by a first distance (D1) and the second bond portion may be separated from a third bond portion by a second distance (D2) that is different from the first distance.

In some embodiments, the longitudinal pattern may be repeated in the longitudinal direction.

In some embodiments, a second adjacent two of the optical fibers may be intermittently connected together by the bond portions arranged in the longitudinal pattern.

In some embodiments, the second adjacent two of the optical fibers may be one of the first adjacent two of the optical fibers.

In some embodiments, a first bond portion of the second adjacent two of the optical fibers is offset from the first bond portion of the first adjacent two of the optical fibers in the longitudinal direction by a first offset length (O1).

In some embodiments, a third adjacent two of the optical fibers may be intermittently connected together by the bond portions arranged in the longitudinal pattern.

In some embodiments, one of the third adjacent two of the optical fibers may be a second one of the second adjacent two of the optical fibers.

In some embodiments, a first bond portion of the third adjacent two of the optical fibers may be offset from the first bond portion of the second adjacent two of the optical fibers in the longitudinal direction by a second offset length (O2) that is different than the first offset length (O1) and may be offset from the first bond portion of the first adjacent two of the optical fibers in the longitudinal direction by a distance equal to O1+O2+BL.

In some embodiments, the intermittent connecting may include bonding.

In some embodiments, the longitudinal pattern of intermittently bonding adjacent optical fibers may be structurally configured to enhance flexibility and robustness of the optical fiber ribbon such that a density of optical fibers in a cable can be increased without increasing a diameter of the cable.

In some embodiments, the first bond portion of the second adjacent two of the optical fibers may not be aligned with the first bond portion of the first adjacent two of the optical fibers in a transverse direction that is perpendicular to the longitudinal direction.

In some embodiments, the first offset length may be different from the first and second distances.

In some embodiments, a second bond portion of the third adjacent two of the optical fibers may be offset from the second bond portion of the second adjacent two of the optical fibers in the longitudinal direction by a third offset length (O3) and may be offset from the second bond portion of the first adjacent two of the optical fibers in the longitudinal direction by a distance equal to O1+O3+BL.

In some embodiments, the second offset length (O2) may be the same as the third offset length (O3). In some embodiments, the second offset length (O2) may be different from the third offset length (O3).

In some embodiments, a n^{th} adjacent two of the optical fibers may be intermittently connected together by the bond portions arranged in a longitudinal pattern where a first bond portion may be separated from a second bond portion by a (n+2)^{th} distance different from the first distance and the second distance, where n≥3.

In some embodiments, a transverse pattern of offsetting a subsequent sequential adjacent two of the optical fibers in the longitudinal direction by the first offset length is repeated in the transverse direction.

### BRIEF DESCRIPTION OF THE FIGURES

FIG. 1 illustrates an exemplary optical fiber cable containing an intermittently bonded optical fiber ribbon in accordance with various aspects of the disclosure.

FIG. 2 illustrates an exemplary intermittently bonded optical fiber ribbon having twelve fibers in accordance with various aspects of the disclosure.

FIG. 3 illustrates an exemplary intermittently bonded optical fiber ribbon having eight fibers in accordance with various aspects of the disclosure.

FIG. 4 illustrates another exemplary intermittently bonded optical fiber ribbon having twelve fibers in accordance with various aspects of the disclosure.

FIG. 5 illustrates a cross sectional view of an exemplary bonding portion between adjacent fibers.

In the drawings, like reference numbers may generally indicate identical, functionally similar, and/or structurally similar elements.

### DETAILED DESCRIPTION

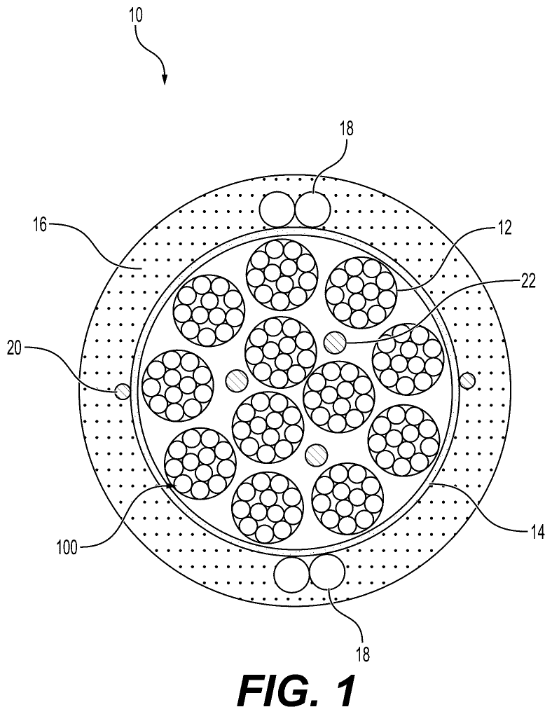

FIG. 1 illustrates an exemplary optical fiber cable 10 containing an intermittently bonded optical fiber ribbon 100 in accordance with various aspects of the disclosure. As shown, the intermittently bonded optical fiber ribbon 100 may be placed inside a buffer tube 12 of the optical fiber cable 10. For example, the optical fiber ribbon 100 may be rolled when placed inside the buffer tube 12. The optical fiber cable 10 may include a water blocking tape 14, a sheath 16, a strength member 18, a ripcord 20, and/or a swellable yarn 22. In some aspects, rather than be placed inside a buffer tube, the intermittently bonded optical fiber ribbon 100 may be rolled and/or bundled together using a binder and disposed loosely in the sheath 16. In the illustrated embodiment, the optical fiber ribbon 100 is a twelve fiber (12F) ribbon. It should be appreciated that the optical fiber cable 10 may be sized to contain any number of buffer tubes and/or bundled intermittently bonded optical fiber ribbons, and/or the buffer tubes may be sized to contain any number of intermittently bonded optical fiber ribbons.

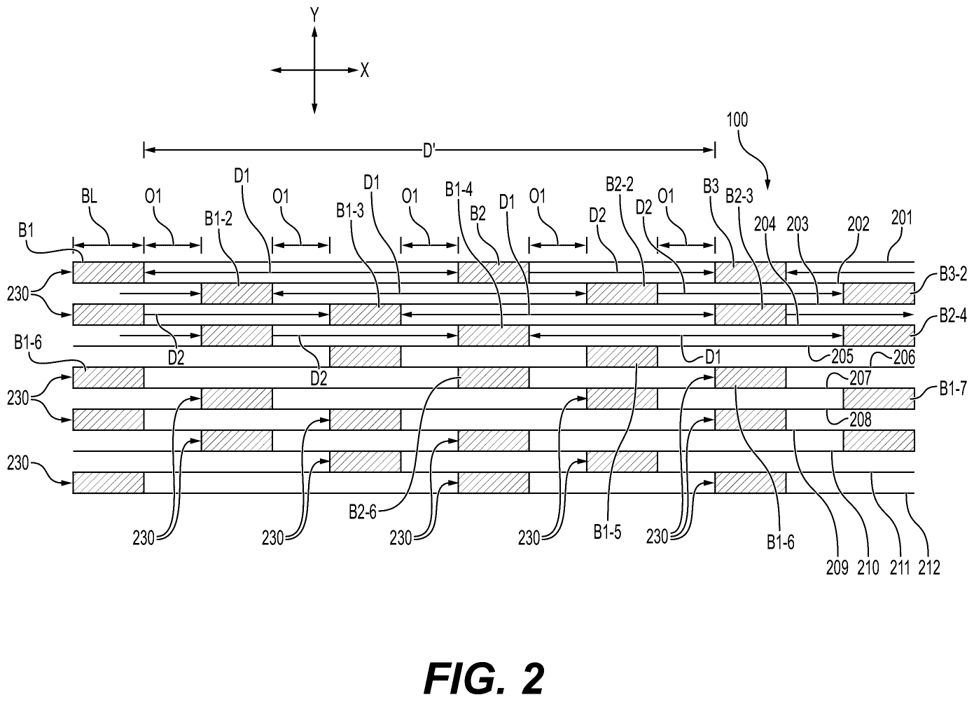

Referring now to FIG. 2, the intermittently bonded optical fiber ribbon 100 includes a plurality of optical transmission elements 201-212, for example, optical fibers. Although the optical fiber ribbon illustrated in FIG. 2 includes twelve fibers (i.e., a 12F ribbon), it should be understood that the features described in this disclosure can be applied to optical fiber ribbons having more or less than twelve fibers.

The optical fibers 201-212 may be configured to generally extend in a longitudinal direction X and may be arranged side-by-side in a direction Y transverse (e.g., perpendicular) to the longitudinal direction X. For example, in the illustrated embodiment, optical fibers 201 and 202 are adjacent to one another, and optical fibers 202 and 203 are adjacent to one another, with optical fiber 202 between optical fibers 201 and 203. Thus, optical fiber 202 may be adjacent to a fiber on opposing sides in the transverse direction Y. This same relationship may exist between adjacent optical fibers from optical fiber 202 to optical fiber 211. However, end optical fibers 201 and 212 may be only adjacent to one other optical fiber.

In the illustrated example of FIG. 2, each of optical fibers 202 to 211 may be connected to adjacent optical fibers on opposing sides in the transverse direction. For example, optical fiber 202 may be bonded to optical fibers 201 and 203, optical fiber 203 may be bonded to optical fibers 202 and 204, optical fiber 204 may be bonded to optical fibers 203 and 205, optical fiber 205 may be bonded to optical fibers 204 and 206, optical fiber 206 may be bonded to optical fibers 205 and 207, optical fiber 207 may be bonded to optical fibers 206 and 208, optical fiber 208 may be bonded to optical fibers 207 and 209, optical fiber 209 may be bonded to optical fibers 208 and 210, optical fiber 210 may be bonded to optical fibers 209 and 211, and optical fiber 211 may be bonded to optical fibers 210 and 212. On the other hand, optical fiber 201 may be only bonded to optical fiber 202 and optical fiber 212 may be only boned to optical fiber 211.

In order to enhance the flexibility of the optical fiber ribbon 100, the adjacent optical fibers may be intermittently connected or bonded to one another to form a connecting portion 230, or bond portion, rather than being bonded or connected to one another along their entire length in the longitudinal direction X. As shown in FIG. 2, in some embodiments, the bond length BL of each of the bond portions 230 in the longitudinal direction X may be the same between all adjacent pairs of the optical fibers 201-212. However, the bond portions 230 may not all align with one another in the transverse direction Y. Instead, in some embodiments, the bond portions 230 may be staggered relative to one another in the transverse direction Y, as discussed in more detail below. In some embodiments, the bond portions 230 may be staggered relative to one another in the transverse direction Y according to a repeating pattern.

As illustrated in FIG. 2, in some embodiments, consecutive bond portions 230 in the longitudinal direction may not be equally spaced from one another in the longitudinal direction X. Instead, each pair of consecutive bond portions 230 in the longitudinal direction may be spaced apart by a different distance. For example, a first bond portion B1 between optical fiber 201 and optical fiber 202 may be spaced from a second bond portion B2 between optical fiber 201 and optical fiber 202 by a first distance D1 in the longitudinal direction. The second bond portion B2 may be spaced from a third bond portion B3 between optical fiber 201 and optical fiber 202 by a second distance D2 in the longitudinal direction that is different than the first distance D1.

In some embodiments, this pattern of two different distances D1, D2 between three consecutive bond portions B1, B2, B3 may be repeated along the length of the first and second optical fibers 201, 202. In some embodiments, this pattern may also be repeated for each consecutive pair of adjacent optical fibers in the transverse direction Y from optical fiber 201 to optical fiber 212.

For example, in some embodiments, the third bond portion B3 may be spaced from a fourth bond portion (not shown) between optical fiber 201 and optical fiber 202 by the first distance D1 in the longitudinal direction, the fourth bond portion may be spaced from a fifth bond portion (not shown) between optical fiber 201 and optical fiber 202 by the second distance D2 in the longitudinal direction. As a result, a distance D′ between the first bond portion B1 and the third bond portion B3 is the same as the distance between the third bond portion B3 and the fifth bond portion.

Looking now at the first, second, and third bond portions B1-2, B2-2, B3-2 between the second optical fiber 202 and the third optical fiber 203, in some embodiments, the same pattern of two different distances D1, D2 between the three consecutive bond portions B1-2, B2-2, B3-2 may be repeated along the length of the second and third optical fibers 202, 203. In some embodiments, that pattern may continue along the length of the second and third optical fibers 202, 203, just as the pattern continued along the length of the first and second optical fibers 201, 202 in some embodiments.

Referring again to FIG. 2, in some embodiments, the first bond portion B1-2 between the second optical fiber 202 and the third optical fiber 203 may be offset from the first bond pattern B1 between the first optical fiber 201 and the second optical fiber 202 by a first offset length O1 in the longitudinal direction X. Similarly, in some embodiments, the second bond portion B2-2 between the second optical fiber 202 and the third optical fiber 203 may be offset from the second bond pattern B2 between the first optical fiber 201 and the second optical fiber 202 by the first offset length O1 in the longitudinal direction X.

In a similar way, in some embodiments, the first bond portion B1-3 between the third optical fiber 203 and the fourth optical fiber 204 may be offset from the first bond portion B1-2 between the second optical fiber 202 and the third optical fiber 203 by the first offset length O1 in the longitudinal direction X, and the second bond portion B2-3 between the third optical fiber 203 and the fourth optical fiber 204 may be offset from the second bond portion B2-2 between the second optical fiber 202 and the third optical fiber 203 by the first offset length O1 in the longitudinal direction X. The first bond portion B1-3 may be spaced from the first bond portion B1 by the distance D2, which is shown to be equal to O1*2+BL.

In some embodiments, the first bond portion B1-4 between the fourth optical fiber 204 and the fifth optical fiber 205 may be offset from the first bond portion B1-3 between the third optical fiber 203 and the fourth optical fiber 204 by the first offset length O1 in the longitudinal direction X, and the second bond portion B2-4 between the fourth optical fiber 204 and the fifth optical fiber 205 may be offset from the second bond portion B2-3 between the third optical fiber 203 and the fourth optical fiber 204 by the first offset length O1 in the longitudinal direction X. The first bond portion B1-4 may be spaced from the first bond portion B1 by the distance D1, which is shown to be equal to O1*3+BL*2. As a result, the first bond portion B1-4 may be aligned with the second bond portion B2 in the transverse direction Y.

In some embodiments, the first bond portion B1-5 between the fifth optical fiber 205 and the sixth optical fiber 206 may be offset from the first bond portion B1-4 between the fourth optical fiber 204 and the fifth optical fiber 205 by the first offset length O1 in the longitudinal direction X, and the second bond portion (not shown) between the fifth optical fiber 205 and the sixth optical fiber 206 may be offset from the second bond portion B2-4 between the fourth optical fiber 204 and the fifth optical fiber 205 by the first offset length O1 in the longitudinal direction X. The first bond portion B1-5 may be spaced from the first bond portion B1 by a distance equal to D1+BL+O1. As a result, the first bond portion B1-5 may be aligned with the second bond portion B2-2 in the transverse direction Y.

In some embodiments, as a result of the repeating longitudinal pattern of the different distances D1, D2 between three consecutive bond portions B1, B2, B3 and the repeated staggering of the repeating longitudinal pattern by the first offset length O1 between each consecutive pair of adjacent optical fibers in the transverse direction Y from optical fiber 201 to optical fiber 212, as described above, the first bond portion B1-6 between the sixth optical fiber 206 and the seventh optical fiber 207 may be aligned with the first bond portion B1 between the first optical fiber 201 and the second optical fiber 202 in the transverse direction Y, and the second bond portion B2-6 between the sixth optical fiber 206 and the seventh optical fiber 207 may be aligned with the second bond portion B2 between the first optical fiber 201 and the second optical fiber 202 in the transverse direction Y.

Similarly, in some embodiments, the first and second bonding portions between the seventh and eighth optical fibers 207, 208 may be aligned with the first and second bonding portions between the second and third optical fibers 202, 203; the first and second bonding portions between the eighth and ninth optical fibers 208, 209 may be aligned with the first and second bonding portions between the third and fourth optical fibers 203, 204; the first and second bonding portions between the ninth and tenth optical fibers 209, 210 may be aligned with the first and second bonding portions between the fourth and fifth optical fibers 204, 205; the first and second bonding portions between the tenth and eleventh optical fibers 210, 211 may be aligned with the first and second bonding portions between the fifth and sixth optical fibers 205, 206; and the first and second bonding portions between the eleventh and twelfth optical fibers 211, 212 may be aligned with the first and second bonding portions between the sixth and seventh optical fibers 206, 207 and the first and second bonding portions between the first and second optical fibers 201, 202.

As illustrated in FIG. 2 and described above, in some embodiments, the bond length BL of the bond portions 230 may be constant, and the two distances D1 and D2 between the three consecutive bonding portions 230 in the longitudinal direction X may not vary from fiber to fiber in the transverse direction Y. In some embodiments, the distances D1 and D2 may be less than 15 mm or greater than 150 mm, and the bond length BL may be less than 3 mm or greater than 20 mm.

The repeating pattern of the two distances D1 and D2 between the three consecutive bond portions 230 in the longitudinal direction X and the staggering of the repeating pattern in the transverse direction Y may be referred to as a “galloping pattern” or “galloping effect” of the intermittent bonding of the optical fibers 201-212 of the optical fiber ribbon 100.

As further illustrated in FIG. 2, in some embodiments, at any cross section of the 12F optical fiber ribbon 100 in the transverse direction X that includes a bond portion 230, the cross section may include at least four bond portions 230, and in some cross sections will include five bond portions 230. It should be understood that the aforementioned galloping pattern can be used in optical fiber ribbons having more than twelve fibers, for example, a 24F optical fiber ribbon. In such optical fiber ribbons having more than twelve fibers, any cross section in the transverse direction X that includes a bond portion 230 may include more bond portions 230 than a 12F cable.

In a first example consistent with the embodiment of FIG. 2, the bond length BL is equal to X, the unbonded length D1 is equal to 10X/3, the unbonded length D2 is equal to 3X, and the distance D3 between adjacent bond portions (e.g., B1 and B1-2) is equal to X. For example, X=BL=20 mm, D1=66.66 mm, D2=60 mm, and D3=20 mm.

In a second example consistent with the embodiment of FIG. 2, the bond length BL is equal to X, the unbonded length D1 is equal to 3X, the unbonded length D2 is equal to 4X, and the distance D3 between adjacent bond portions (e.g., B1 and B1-2) is equal to X. For example, X=BL=20 mm, D1=60 mm, D2=80 mm, and D3=20 mm.

In a third example consistent with the embodiment of FIG. 2, the bond length BL is equal to X, the unbonded length D1 is equal to 3X, the unbonded length D2 is equal to 9X/2, and the distance D3 between adjacent bond portions (e.g., B1 and B1-2) is equal to X. For example, X=BL=20 mm, D1=60 mm, D2=90 mm, and D3=20 mm.

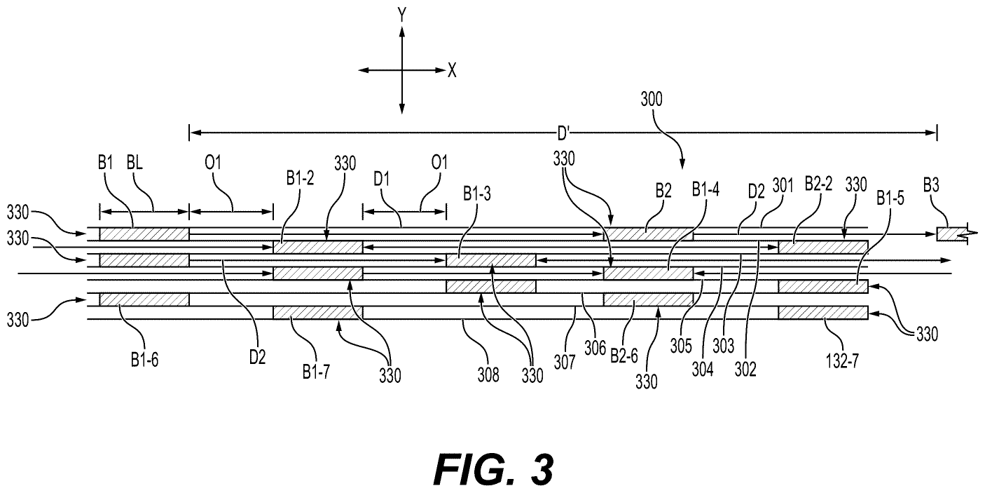

FIG. 3 illustrates an exemplary intermittently bonded optical fiber ribbon 300 that includes eight optical transmission elements 301-308, for example, optical fibers.

In some embodiments, the optical fibers 301-308 may be configured to generally extend in a longitudinal direction X and may be arranged side-by-side in a direction Y transverse (e.g., perpendicular) to the longitudinal direction X. For example, optical fibers 301 and 302 may be adjacent to one another, and optical fibers 302 and 303 may be adjacent to one another, with optical fiber 302 between optical fibers 301 and 303. Thus, optical fiber 302 may be adjacent to a fiber on opposing sides in the transverse direction Y. This same relationship may exist between adjacent optical fibers from optical fiber 302 to optical fiber 307. However, end optical fibers 301 and 308 may be only adjacent to one other optical fiber.

As illustrated in FIG. 3, in some embodiments, each of optical fibers 302 to 307 may be connected to adjacent optical fibers on opposing sides in the transverse direction. For example, optical fiber 302 may be bonded to optical fibers 301 and 303, optical fiber 303 may be bonded to optical fibers 302 and 304, optical fiber 304 may be bonded to optical fibers 303 and 305, optical fiber 305 may be bonded to optical fibers 304 and 306, optical fiber 306 may be bonded to optical fibers 305 and 307, and optical fiber 307 may be bonded to optical fibers 306 and 308. On the other hand, optical fiber 301 may be only bonded to optical fiber 302 and optical fiber 308 may be only bonded to optical fiber 307.

In order to enhance the flexibility of the optical fiber ribbon 300, the adjacent optical fibers may be intermittently connected or bonded to one another to form a connecting portion 330, or bond portion, rather than being bonded or connected to one another along their entire length in the longitudinal direction X. As shown in FIG. 3, in some embodiments, the bond length BL of each of the bond portions 330 in the longitudinal direction X may be the same between all adjacent pairs of the optical fibers 301-308. However, in some embodiments, the bond portions 330 may not all align with one another in the transverse direction Y. Instead, the bond portions 330 may be staggered relative to one another in the transverse direction Y, as discussed in more detail below. In some embodiments, the bond portions 330 may be staggered relative to one another in the transverse direction Y according to a repeating pattern.

As illustrated in FIG. 3, in some embodiments, consecutive bond portions 330 in the longitudinal direction may not be equally spaced from one another in the longitudinal direction X. Instead, each pair of consecutive bond portions 330 in the longitudinal direction may be spaced apart by a different distance. For example, in some embodiments, a first bond portion B1 between optical fiber 301 and optical fiber 302 may be spaced from a second bond portion B2 between optical fiber 301 and optical fiber 302 by a first distance D1 in the longitudinal direction. The second bond portion B2 may be spaced from a third bond portion B3 between optical fiber 301 and optical fiber 302 by a second distance D2 in the longitudinal direction different than the first distance D1.

In some embodiments, his pattern of two different distances D1, D2 between three consecutive bond portions B1, B2, B3 may be repeated along the length of the first and second optical fibers 301, 302. In some embodiments, this pattern may also be repeated for each consecutive pair of adjacent optical fibers in the transverse direction Y from optical fiber 301 to optical fiber 308.

For example, in some embodiments, the third bond portion B3 may be spaced from a fourth bond portion (not shown) between optical fiber 301 and optical fiber 302 by the first distance D1 in the longitudinal direction, the fourth bond portion may be spaced from a fifth bond portion (not shown) between optical fiber 301 and optical fiber 302 by the second distance D2 in the longitudinal direction. As a result, a distance D′ between the first bond portion B1 and the third bond portion B3 may be the same as the distance between the third bond portion B3 and the fifth bond portion.

Looking now at the first, second, and third bond portions B1-2, B2-2, B3-2 between the second optical fiber 302 and the third optical fiber 303, in some embodiments, the same pattern of two different distances D1, D2 between the three consecutive bond portions B1-2, B2-2, B3-2 may be repeated along the length of the second and third optical fibers 302, 303. In some embodiments, that pattern may continue along the length of the second and third optical fibers 302, 303, just as the pattern, in some embodiments, continued along the length of the first and second optical fibers 301, 302.

Referring again to FIG. 3, in some embodiments, the first bond portion B1-2 between the second optical fiber 302 and the third optical fiber 303 may be offset from the first bond pattern B1 between the first optical fiber 301 and the second optical fiber 302 by a first offset length O1 in the longitudinal direction X. Similarly, in some embodiments, the second bond portion B2-2 between the second optical fiber 302 and the third optical fiber 303 may be offset from the second bond pattern B2 between the first optical fiber 301 and the second optical fiber 302 by the first offset length O1 in the longitudinal direction X.

In a similar way, in some embodiments, the first bond portion B1-3 between the third optical fiber 303 and the fourth optical fiber 304 may be offset from the first bond portion B1-2 between the second optical fiber 302 and the third optical fiber 303 by the first offset length O1 in the longitudinal direction X, and the second bond portion B2-3 between the third optical fiber 303 and the fourth optical fiber 304 may be offset from the second bond portion B2-2 between the second optical fiber 302 and the third optical fiber 303 by the first offset length O1 in the longitudinal direction X. The first bond portion B1-3 may be spaced from the first bond portion B1 by the distance D2, which is shown to be equal to O1*2+BL.

In some embodiments, the first bond portion B1-4 between the fourth optical fiber 304 and the fifth optical fiber 305 may be offset from the first bond portion B1-3 between the third optical fiber 303 and the fourth optical fiber 304 by the first offset length O1 in the longitudinal direction X, and the second bond portion B2-4 between the fourth optical fiber 304 and the fifth optical fiber 305 may be offset from the second bond portion B2-3 between the third optical fiber 303 and the fourth optical fiber 304 by the first offset length O1 in the longitudinal direction X. The first bond portion B1-4 may be spaced from the first bond portion B1 by the first offset length O1, which is shown to be equal to O1*3+BL*2. As a result, in some embodiments, the first bond portion B1-4 may be aligned with the second bond portion B2 in the transverse direction Y.

In some embodiments, the first bond portion B1-5 between the fifth optical fiber 305 and the sixth optical fiber 306 may be offset from the first bond portion B1-4 between the fourth optical fiber 304 and the fifth optical fiber 305 by the first offset length O1 in the longitudinal direction X, and the second bond portion (not shown) between the fifth optical fiber 305 and the sixth optical fiber 306 may be offset from the second bond portion B2-4 between the fourth optical fiber 304 and the fifth optical fiber 305 by the first offset length O1 in the longitudinal direction X. The first bond portion B1-5 is spaced from the first bond portion B1 by a distance equal to D1+BL+O1. As a result, in some embodiments, the first bond portion B1-5 may be aligned with the second bond portion B2-2 in the transverse direction Y.

In some embodiments, the offset lengths (e.g., the first offset length O1) may vary. For example, in some embodiments, the first bond portion B1-2 between the second optical fiber 302 and the third optical fiber 303 may be offset from the first bond pattern B1 between the first optical fiber 301 and the second optical fiber 302 by a first offset length O1 in the longitudinal direction X and the second bond portion B2-2 between the second optical fiber 302 and the third optical fiber 303 may be offset from the second bond pattern B2 between the first optical fiber 301 and the second optical fiber 302 by an offset length in the longitudinal direction X that is different than the first offset length.

In some embodiments, as a result of the repeating longitudinal pattern of the different distances D1, D2 between three consecutive bond portions B1, B2, B3 and the repeated staggering of the repeating longitudinal pattern by the first offset length O1 between each consecutive pair of adjacent optical fibers in the transverse direction Y from optical fiber 301 to optical fiber 308, as described above, the first bond portion B1-6 between the sixth optical fiber 306 and the seventh optical fiber 307 may be aligned with the first bond portion B1 between the first optical fiber 301 and the second optical fiber 302 in the transverse direction Y, and the second bond portion B2-6 between the sixth optical fiber 306 and the seventh optical fiber 307 may be aligned with the second bond portion B2 between the first optical fiber 301 and the second optical fiber 302 in the transverse direction Y. Similarly, in some embodiments, the first and second bonding portions between the seventh and eighth optical fibers 307, 308 may be aligned with the first and second bonding portions between the second and third optical fibers 302, 303.

As illustrated in FIG. 3 and described above, in some embodiments, the bond length BL of the bond portions 330 may be constant, and the two distances D1 and D2 between the three consecutive bonding portions 330 in the longitudinal direction X may not vary from fiber to fiber in the transverse direction Y. As further illustrated in FIG. 3, in some embodiments, at any cross section of the 8F optical fiber ribbon 300 in the transverse direction X that includes a bond portion 330, the cross section may include at least two bond portions 330, and in some cross sections may include three bond portions 330.

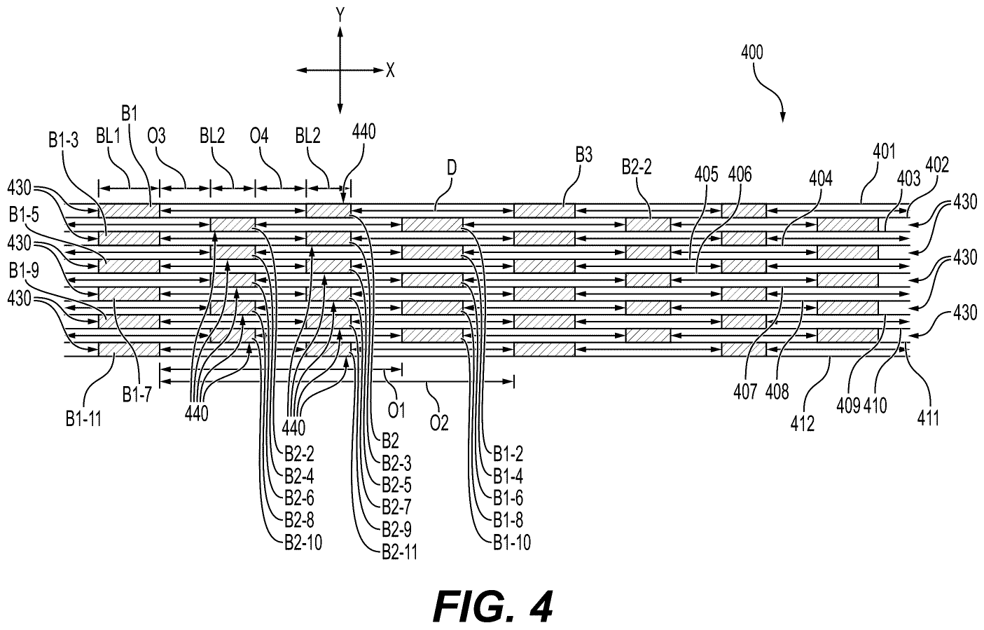

FIG. 4 illustrates another exemplary intermittently bonded optical fiber ribbon 400 that includes twelve optical transmission elements 401-412, for example, optical fibers.

In some embodiments, the optical fibers 401-412 may be configured to generally extend in a longitudinal direction X and may be arranged side-by-side in a direction Y transverse (e.g., perpendicular) to the longitudinal direction X. For example, in some embodiments, optical fibers 401 and 402 may be adjacent to one another, and optical fibers 402 and 403 may be adjacent to one another, with optical fiber 402 between optical fibers 401 and 403. Thus, in some embodiments, optical fiber 402 may be adjacent to a fiber on opposing sides in the transverse direction Y. In some embodiments, this same relationship may exist between adjacent optical fibers from optical fiber 402 to optical fiber 411. However, in some embodiments, end optical fibers 401 and 412 may be only adjacent to one other optical fiber.

As illustrated in FIG. 4, in some embodiments, each of optical fibers 402 to 411 may be connected to adjacent optical fibers on opposing sides in the transverse direction. For example, in some embodiments, optical fiber 402 may be bonded to optical fibers 401 and 403, optical fiber 403 may be bonded to optical fibers 402 and 404, optical fiber 404 may be bonded to optical fibers 403 and 405, optical fiber 405 may be bonded to optical fibers 404 and 406, optical fiber 406 may be bonded to optical fibers 405 and 407, optical fiber 407 may be bonded to optical fibers 406 and 408, optical fiber 408 may be bonded to optical fibers 407 and 409, optical fiber 409 may be bonded to optical fibers 408 and 410, optical fiber 410 may be bonded to optical fibers 409 and 411, and optical fiber 411 may be bonded to optical fibers 410 and 412. On the other hand, in some embodiments, optical fiber 401 may be only bonded to optical fiber 402 and optical fiber 412 may be only bonded to optical fiber 411.

In order to enhance the flexibility of the optical fiber ribbon 400, in some embodiments, the adjacent optical fibers may be intermittently connected or bonded to one another to form a connecting portion 430, 440, or bond portion, rather than being bonded or connected to one another along their entire length in the longitudinal direction X. As shown in FIG. 4, in some embodiments, the bond portions 430, 440 may include different bond lengths BL1, BL2, respectively, in the longitudinal direction X, with the bond portions 430, 440 being separated by a constant length D (i.e., unbonded section).

In some embodiments, this pattern of two different bond lengths BL1, BL2 separated by a constant length D may be repeated along the length of the first and second optical fibers 401, 402. In some embodiments, this pattern may be also repeated for each consecutive pair of adjacent optical fibers in the transverse direction Y from optical fiber 401 to optical fiber 412. For example, in some embodiments, the first and second bond portions B1-2, B2-2 between the second optical fiber 402 and the third optical fiber 403 may follow the same pattern of different bond lengths BL1, BL2 separated by a constant length D as the first and second bond portions B1, B2 between the first optical fiber 401 and the second optical fiber 402. In some embodiments, that pattern may continue along the length of the second and third optical fibers 402, 403, just as the pattern continued along the length of the first and second optical fibers 401, 402.

As shown in FIG. 4, in some embodiments, the bond portions 430, 440 of adjacent pairs of the optical fibers 401-412 may be arranged such that at least five bond portions 430, 440 may be aligned with one another in the transverse direction Y. It should be appreciated that the number of bond portions 430, 440 aligned with one another in the transverse direction Y may be varied such that more or less than five bond portions 430, 440 are aligned in the transverse direction Y, depending on how the bond portions 430, 440 are staggered relative to one another in the transverse direction Y.

Referring again to FIG. 4, in some embodiments, the first bond portion B1-2 between the second optical fiber 402 and the third optical fiber 403 may be offset from the first bond portion B1 between the first optical fiber 401 and the second optical fiber 402 by a first offset length O1 in the longitudinal direction X. Similarly, the second bond portion B2-2 between the second optical fiber 402 and the third optical fiber 403 may be offset from the second bond portion B2 between the first optical fiber 401 and the second optical fiber 402 by the first offset length O1 in the longitudinal direction X. The third bond portion B3 may be offset from the first bond portion B1 by a second offset length O2. Meanwhile, the second bond portion B2-2 may be offset from the first bond portion B1 by a third offset length O3 in the longitudinal direction X, and the second bond portion B2 may be offset from the second bond portion B2-2 by a fourth offset length O4 in the longitudinal direction X. In some embodiments, the offset lengths O3, O4 may be the same, and in some embodiments, the offset lengths O3 and O4 may be different.

As illustrated, in some embodiments, the first bond portion B1-3 between the third optical fiber 403 and the fourth optical fiber 404 may be aligned with the first bond portion B1 between the first optical fiber 401 and the second optical fiber 402 in the transverse direction Y, and the second bond portion B2-3 between the third optical fiber 403 and the fourth optical fiber 404 may be aligned with the second bond portion B2 between the first optical fiber 401 and the second optical fiber 402 in the transverse direction Y.

In some embodiments, the first bond portion B1-4 between the fourth optical fiber 404 and the fifth optical fiber 405 may be aligned with the first bond portion B1-2 between the second optical fiber 402 and the third optical fiber 403 in the transverse direction Y, and the second bond portion B2-4 between the fourth optical fiber 404 and the fifth optical fiber 405 may be aligned with the second bond portion B2-2 between the second optical fiber 402 and the third optical fiber 403 in the transverse direction Y. As noted above, in some embodiments, this pattern may be repeated for each consecutive pair of adjacent optical fibers in the transverse direction Y from optical fiber 401 to optical fiber 412.

In some embodiments, as a result of the repeating longitudinal pattern of the different bond lengths BL1, BL2 of the bond portions B1, B2, B3, B4 and the constant distance D between three consecutive bond portions B1, B2, B3 and the repeated staggering of the repeating longitudinal pattern by the first offset length O1 between each consecutive pair of adjacent optical fibers in the transverse direction Y from optical fiber 401 to optical fiber 412, as described above, the first bond portions B1-5, B1-7, B1-9, and B1-11 may be aligned with the first bond portions B1 and B1-3 in the transverse direction Y, and the first bond portions B1-6, B1-8, and B1-10 may be aligned with the first bond portions B1-2 and B1-4 in the transverse direction Y. Similarly, in some embodiments, the second bond portions B2-5, B2-7, B2-9, and B2-11 may be aligned with the second bond portions B2 and B2-3 in the transverse direction Y, and the second bond portions B2-6, B2-8, and B2-10 may be aligned with the second bond portions B2-2 and B2-4 in the transverse direction Y.

As illustrated in FIG. 4 and described above, in some embodiments, the bond lengths BL1, BL2 of the bond portions 430, 440 may be different, and the D between consecutive bonding portions 430, 440 in the longitudinal direction X may not vary from fiber to fiber in the transverse direction Y. In some aspects, the distance D may be less than 15 mm or greater than 150 mm, and the bond lengths BL1, BL2 may be less than 3 mm or greater than 20 mm. This repeating pattern in the longitudinal direction X and the staggering of the repeating pattern in the transverse direction Y may be referred to as a “galloping pattern” or “galloping effect” of the intermittent bonding of the optical fibers 401-412 of the optical fiber ribbon 100.

As further illustrated in FIG. 4, in some embodiments, at any cross section of the 12F optical fiber ribbon 400 in the transverse direction X that includes a bond portion 430, 440, the cross section may include at least five bond portions 430, 440, and in some cross sections may include six bond portions 430, 440. It should be understood that the aforementioned galloping pattern can be used in optical fiber ribbons having more than twelve fibers, for example, a 24F optical fiber ribbon. In such optical fiber ribbons having more than twelve fibers, any cross section in the transverse direction X that includes a bond portion 430 may include more bond portions 430 than a 12F cable. It should be understood that the aforementioned galloping pattern can be used in optical fiber ribbons having less than twelve fibers, for example, an 8F optical fiber ribbon.

In a first example consistent with the illustrated embodiment of FIG. 4, the first bond length BL1 is equal to X, the second bond length BL2 is equal to 3X, the unbonded length D is equal to 7X, and a length d between two adjacent bond portions having the same bond length BL1 (e.g., B1 and B1-2) is equal to X. For example, X=BL1=20 mm, BL2=60 mm, D=140 mm, and d=20 mm.

In a second example consistent with the illustrated embodiment of FIG. 4, the first bond length BL1 is equal to X, the second bond length BL2 is equal to 3X, the unbonded length D is equal to 7X, and a length d between two adjacent bond portions having the same bond length BL1 (e.g., B1 and B1-2) is equal to 2X. For example, X=BL1=20 mm, BL2=60 mm, D=140 mm, and d=40 mm.

In a third example consistent with the embodiment of FIG. 4, the first bond length BL1 is equal to X, the second bond length BL2 is equal to 3X, the unbonded length D is equal to 7X, and a length d between two adjacent bond portions having the same bond length BL1 (e.g., B1 and B1-2) is equal to 3X. For example, X=BL1=20 mm, BL2=60 mm, D=140 mm, and d=60 mm.

In a fourth example consistent with the embodiment of FIG. 4, the first bond length BL1 is equal to 2X, the second bond length BL2 is equal to 3X, the unbonded length D is equal to 7X, and a length d between two adjacent bond portions having the same bond length BL1 (e.g., B1 and B1-2) is equal to 2X. For example, X=20 mm, BL1=40 mm, BL2=60 mm, D=140 mm, and d=40 mm.

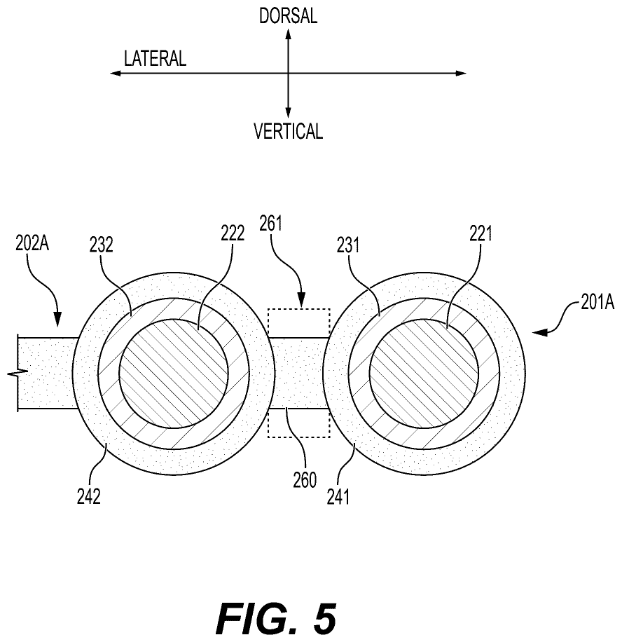

Referring now to FIG. 5, adjacent optical fibers (e.g., optical fibers 201, 202) of the optical fiber ribbon 100, 300, 400 may comprise individual conductors 201A, 202A that are bonded together via a bonding material. The conductors 201A, 202A may include signal transmission portions or optical fibers 221, 222, respectively. In some implementations, optical fibers 221, 222 (referred to generally as fibers) may be encapsulated in a cover portion 231, 232, for example, a coating, which may comprise an insulating or dielectric material, such as polyvinyl chloride (PVC), polytetrafluoroethylene (PTFE or Teflon), polyvinylidene fluoride (PVDF), UV-curable materials including acrylate, epoxy, polyester, silicone, or styrene copolymer based materials, or any other such material. The conductors 201A, 202A may be bonded to one another via a bonding material 260, which may comprise silicone rubber, polyvinyl chloride (PVC), polytetrafluoroethylene (PTFE or Teflon), polyvinylidene fluoride (PVDF), fluorine resin, UV-curable materials including acrylate, epoxy, polyester, silicone, or styrene copolymer based materials, or any other such material, shown as a first portion 241 and a second portion 242 respectively attached to fiber 221 (via coating 231), and fiber 222 (via coating 232).

In the implementation shown, the bonding material 260 may completely surround the coatings 231, 232, though in other implementations, less bonding material may be employed. For example, the bonding material may only cover a portion of the coatings 231, 232. The bonding material 260 may include a separation portion 261 (shown in dotted line) between the coatings 231, 232 and/or the fibers 221, 222. In many such implementations lacking the preferential separation features discussed herein below, the bonding material 260 may be laterally symmetrical around a vertical plane across the ribbon cable as shown. The bonding material also may be vertically symmetrical around a horizontal plane through the ribbon cable as shown (e.g., with identical dorsal and ventral portions). In some aspects, the bonding material 260 may not be laterally symmetrical and/or vertically symmetrical.

The intermittent bonding pattern described herein is structurally configured to reduce the overall amount of matrix material needed to intermittently bond adjacent fibers of the optical fiber ribbon 100, 300, 400. As a result, the optical fiber ribbon 100, 300, 400 may be provided with enhanced flexibility relative to fully bonded optical fiber ribbons and other intermittently bonded optical fiber ribbons. Such enhanced flexibility permits the optical fiber cable 10 to contain a greater number of optical fiber ribbons without increasing the diameter of the cable, thereby maximizing fiber density in the cable.

The intermittent bonding pattern described herein is structurally configured to provide the robustness needed to offer easy handling of the optical fiber ribbon 100, 300, 400 during processing and installation. For example, the intermittent bonding pattern described herein is configured to balance enhanced flexibility and robustness of the optical fiber ribbon 100, 300, 400 by largely bonding the optical fibers 201-212, 301-308, 401-412 as pairs but providing some intermittency to the bond structure to allow for additional flexibility.

The above description in conjunction with the above-reference drawings sets forth a variety of embodiments for exemplary purposes, which are in no way intended to limit the scope of the disclosure. Those having skill in the relevant art can modify the described apparatus and methods in various ways without departing from the broadest scope of the disclosure. Thus, the scope of the apparatus and methods described herein should not be limited by any of the exemplary embodiments and should be defined in accordance with the accompanying claims and their equivalents.

What is claimed is:

1. An optical fiber ribbon intermittently bonded with a repeating pattern of bond lengths and gap lengths configured to enhance flexibility and robustness of the optical fiber ribbon, comprising:
a plurality of optical fibers arranged in parallel;
a connecting portion configured to connect adjacent optical fibers together;
wherein the connecting portion includes bond portions that are configured to be spaced apart from one another in a longitudinal direction;
wherein the bond portions comprise a constant bond length (BL);
wherein a first adjacent two of the optical fibers are intermittently connected together by the bond portions arranged in a longitudinal pattern where a first bond portion is separated from a second bond portion by a first distance (D1) and the second bond portion is separated from a third bond portion by a second distance (D2) that is different from the first distance;
wherein the longitudinal pattern is repeated in the longitudinal direction;
wherein a second adjacent two of the optical fibers are intermittently connected together by the bond portions arranged in the longitudinal pattern;
wherein one of the second adjacent two of the optical fibers is one of the first adjacent two of the optical fibers;
wherein a first bond portion of the second adjacent two of the optical fibers is offset from the first bond portion of the first adjacent two of the optical fibers in the longitudinal direction by a first offset length (O1) that is different from the first and second distances;
wherein the first bond portion of the second adjacent two of the optical fibers is not aligned with the first bond portion of the first adjacent two of the optical fibers in a transverse direction that is perpendicular to the longitudinal direction;
wherein a third adjacent two of the optical fibers are intermittently connected together by the bond portions arranged in the longitudinal pattern;
wherein one of the third adjacent two of the optical fibers is a second one of the second adjacent two of the optical fibers;
wherein a first bond portion of the third adjacent two of the optical fibers is offset from the first bond portion of the second adjacent two of the optical fibers in the longitudinal direction by a second offset length (O2) and is offset from the first bond portion of the first adjacent two of the optical fibers in the longitudinal direction by a distance equal to O1+O2+BL;
wherein a second bond portion of the third adjacent two of the optical fibers is offset from the second bond portion of the second adjacent two of the optical fibers in the longitudinal direction by a third offset length (O3) and is offset from the second bond portion of the first adjacent two of the optical fibers in the longitudinal direction by a distance equal to O1+O3+BL;
wherein the intermittent connecting comprises bonding; and
wherein the longitudinal pattern of intermittently bonding adjacent optical fibers is structurally configured to enhance flexibility and robustness of the optical fiber ribbon such that a density of optical fibers in a cable can be increased without increasing a diameter of the cable.

2. The optical fiber ribbon of claim 1, wherein the second offset length (O2) is the same as the third offset length (O3).

3. The optical fiber ribbon of claim 1, wherein the second offset length (O2) is different from the third offset length (O3).

4. The optical fiber ribbon of claim 1, wherein an n^{th} adjacent two of the optical fibers are intermittently connected together by the bond portions arranged in a longitudinal pattern where a first bond portion is separated from a second bond portion by a (n+2)^{th} distance different from the first distance and the second distance, where n≥3.

5. The optical fiber ribbon of claim 1, wherein a transverse pattern of offsetting a subsequent sequential adjacent two of the optical fibers in the longitudinal direction by the first offset length is repeated in the transverse direction.

6. An optical fiber cable comprising:
the optical fiber ribbon of claim 1 disposed in a buffer tube;
a strength member; and
a sheath configured to surround the optical fiber ribbon, the buffer tube and the strength member.

7. An optical fiber cable comprising:
the optical fiber ribbon of claim 1 bundled with a binder;
a strength member; and
a sheath configured to surround the optical fiber ribbon and the strength member.

8. An optical fiber ribbon intermittently bonded with a repeating pattern of bond lengths and gap lengths configured to enhance flexibility and robustness of the optical fiber ribbon, comprising:
a plurality of optical fibers arranged in parallel;
a connecting portion configured to connect adjacent optical fibers together;
wherein the connecting portion includes bond portions that are configured to be spaced apart from one another in a longitudinal direction;
wherein the bond portions comprise a constant bond length (BL);
wherein a first adjacent two of the optical fibers are intermittently connected together by the bond portions arranged in a longitudinal pattern where a first bond portion is separated from a second bond portion by a first distance (D1) and the second bond portion is separated from a third bond portion by a second distance (D2) that is different from the first distance;
wherein the longitudinal pattern is repeated in the longitudinal direction;
wherein a second adjacent two of the optical fibers are intermittently connected together by the bond portions arranged in the longitudinal pattern;
wherein one of the second adjacent two of the optical fibers is one of the first adjacent two of the optical fibers;
wherein a first bond portion of the second adjacent two of the optical fibers is offset from the first bond portion of the first adjacent two of the optical fibers in the longitudinal direction by a first offset length (O1);
wherein a third adjacent two of the optical fibers are intermittently connected together by the bond portions arranged in the longitudinal pattern;
wherein one of the third adjacent two of the optical fibers is a second one of the second adjacent two of the optical fibers;
wherein a first bond portion of the third adjacent two of the optical fibers is offset from the first bond portion of the second adjacent two of the optical fibers in the longitudinal direction by a second offset length (O2) that is different than the first offset length (O1) and is offset from the first bond portion of the first adjacent two of the optical fibers in the longitudinal direction by a distance equal to O1+O2+BL;
wherein the intermittent connecting comprises bonding; and
wherein the longitudinal pattern of intermittently bonding adjacent optical fibers is structurally configured to enhance flexibility and robustness of the optical fiber ribbon such that a density of optical fibers in a cable can be increased without increasing a diameter of the cable.

9. The optical fiber ribbon according to claim 8, wherein the first bond portion of the second adjacent two of the optical fibers is not aligned with the first bond portion of the first adjacent two of the optical fibers in a transverse direction that is perpendicular to the longitudinal direction.

10. The optical fiber ribbon according to claim 8, wherein the first offset length is different from the first and second distances.

11. The optical fiber ribbon according to claim 8, wherein a second bond portion of the third adjacent two of the optical fibers is offset from the second bond portion of the second adjacent two of the optical fibers in the longitudinal direction by a third offset length (O3) and is offset from the second bond portion of the first adjacent two of the optical fibers in the longitudinal direction by a distance equal to O1+O3+BL.

12. The optical fiber ribbon according to claim 11, wherein the second offset length (O2) is the same as the third offset length (O3).

13. The optical fiber ribbon according to claim 11, wherein the second offset length (O2) is different from the third offset length (O3).

14. The optical fiber ribbon according to claim 8, wherein an n^{th} adjacent two of the optical fibers are intermittently connected together by the bond portions arranged in a longitudinal pattern where a first bond portion is separated from a second bond portion by a (n+2)^{th} distance different from the first distance and the second distance, where n≥3.

15. The optical fiber ribbon according to claim 8, wherein a transverse pattern of offsetting a subsequent sequential adjacent two of the optical fibers in the longitudinal direction by the first offset length is repeated in the transverse direction.

16. An optical fiber ribbon intermittently bonded with a repeating pattern of bond lengths and gap lengths configured to enhance flexibility and robustness of the optical fiber ribbon, comprising
a plurality of optical fibers arranged in parallel;
a connecting portion configured to connect adjacent optical fibers together;
wherein the connecting portion includes bond portions that are configured to be spaced apart from one another in a longitudinal direction;
wherein a first adjacent two of the optical fibers are intermittently connected together by the bond portions arranged in a longitudinal pattern where a first bond portion is separated from a second bond portion by a distance and the second bond portion is separated from a third bond portion by the distance D;
wherein the first bond portion has a first bond length BL1 and the second bond portion has a second bond length BL2 that is different than the first bond length BL1;
wherein the longitudinal pattern is repeated in the longitudinal direction;
wherein a second adjacent two of the optical fibers are intermittently connected together by the bond portions arranged in the longitudinal pattern;
wherein one of the second adjacent two of the optical fibers is one of the first adjacent two of the optical fibers;
wherein a first bond portion of the second adjacent two of the optical fibers is offset from the first bond portion of the first adjacent two of the optical fibers in the longitudinal direction by a first offset length (O1)
wherein the first bond portion of the second adjacent two of the optical fibers is not aligned with the first bond portion of the first adjacent two of the optical fibers in a transverse direction that is perpendicular to the longitudinal direction;
wherein a third adjacent two of the optical fibers are intermittently connected together by the bond portions arranged in the longitudinal pattern;
wherein one of the third adjacent two of the optical fibers is a second one of the second adjacent two of the optical fibers;
wherein a first bond portion of the third adjacent two of the optical fibers is offset from the first bond portion of the second adjacent two of the optical fibers in the longitudinal direction by a second offset length (O2) and is offset from the first bond portion of the first adjacent two of the optical fibers in the longitudinal direction by a distance equal to O1+O2+BL2;
wherein the intermittent connecting comprises bonding; and
wherein the longitudinal pattern of intermittently bonding adjacent optical fibers is structurally configured to enhance flexibility and robustness of the optical fiber ribbon such that a density of optical fibers in a cable can be increased without increasing a diameter of the cable.

17. The optical fiber ribbon according to claim 16, wherein the first bond length is greater than the second bond length.

18. The optical fiber ribbon according to claim 16, wherein the first bond length is less than the second bond length.

19. An optical fiber cable comprising:
the optical fiber ribbon of claim 18 disposed in a buffer tube;
a strength member; and
a sheath configured to surround the optical fiber ribbon, the buffer tube and the strength member.

20. An optical fiber cable comprising:
the optical fiber ribbon of claim 18 bundled with a binder;
a strength member; and
a sheath configured to surround the optical fiber ribbon and the strength member.
